(19) United States
(12) Patent Application Publication
(10) Pub. No.: US 2011/0202365 A1
(43) Pub. Date: Aug. 18, 2011

(54) Systems and Methods for Providing Personalized Health Care

(76) Inventor: Sukhwant Singh Khanuja, Chicago, IL (US)

(21) Appl. No.: 13/030,097

(22) Filed: Feb. 17, 2011

Related U.S. Application Data
(60) Provisional application No. 61/305,259, filed on Feb. 17, 2010.

(51) Int. Cl. G06Q 50/00

(52) U.S. Cl. 705/2

(57) ABSTRACT

A system and method is provided for personalized health care. In one embodiment, a patent monitors one or more of their biometric characteristics using a biometric data reader several times a day for at least several days. The biometric data is then passed to a central server that reviews the biometric data and determines if there are any undesirable spikes or troughs in the readings. If so, then the timing of the patient taking their medication is adjusted so that more medication is available in the patient's system when needed to combat the spikes or troughs.

### CROSS-REFERENCE TO RELATED APPLICATIONS

The present application claims the benefit of U.S. Provisional Application No. 61/305,259, filed Feb. 17, 2010 entitled “Method For Predicting Patient Health And For Providing Personalized Care And Triggering Timely Intervention.”

### BACKGROUND OF THE INVENTION

The present invention generally relates to providing patients with health care for their health problems. More specifically, the present invention relates to providing personalized health care to patients, especially with regard to the administration of pharmaceuticals.

Care is conventionally planned on a uniform basis for a cross-section of population. However, people have different lifestyles, eating habits, work schedules, etc. All of this is not always taken into account when a care program is developed. For example, all adults will get a tablet having a standard dose, such as 500 mg of a pharmaceutical agent. Does the same dose provide an equal impact for a 100-pound female as a 300-pound male? Another example is that all patients who have been prescribed a medication are asked to take a medication once per day. How does a clinician or patient determine whether the patient should take it in the morning and another in the evening?

Patients fall sick and are treated for their specific identified ailments. This action is reactive and does not prevent the patient from decompensating or their health deteriorating, and possibly ending up in an emergency room and/or being hospitalized. Usually active treatment only starts once the patient is in clinical care. Timely intervention could prevent patient decompensation and thus clinical healthcare treatment including an emergency room visit or hospitalization. Preventing these clinical treatments would save a lot of money for the payer for these treatments as well as improve the quality of patients' lives.

### BRIEF SUMMARY OF THE INVENTION

One or more of the embodiments of the present invention provide a personalized health care system. In one embodiment, a patient monitors one or more of their biometric characteristics using a biometric data reader several times a day for at least several days. The biometric data is then passed to a central server that reviews the biometric data and determines if there are any undesirable spikes or troughs in the readings. If so, then the timing of the patient taking their medication is adjusted so that more medication is available in the patient's system when needed to combat the spike.

### BRIEF DESCRIPTION OF THE DRAWINGS

FIG. 1 illustrates a personalized health care system according to an embodiment of the present invention.

FIG. 2 illustrates a personalized modification of a medication schedule based on personally measured medical data.

FIG. 3 illustrates a flowchart of the personalized health care system.

### DETAILED DESCRIPTION OF THE INVENTION

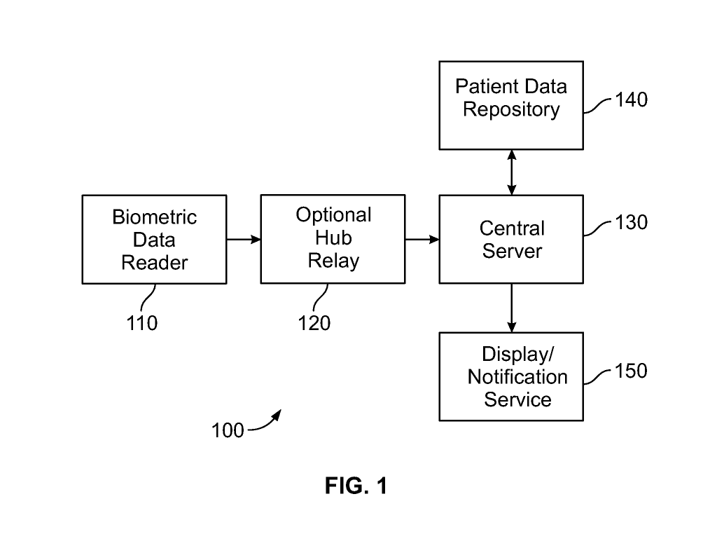

FIG. 1 illustrates a personalized health care system 100 according to an embodiment of the present invention. The personalized health care system 100 includes a biometric data reader 110, an optional hub relay 120, a central server 130, a patient data repository 140, and a notification/display service 150.

In operation, biometric data is read from a patient at the biometric data reader 110 and then passed to the central server 130. The biometric data may pass through the optional hub relay 120 if the hub relay 120 is present. Once data is received at the central server 130, it may be stored in the patient data repository 140. Patient data may later be retrieved and displayed from the patient data repository 140 using a display/notification service 150, which may for example be a computer application operating over a network or the internet.

In a typical situation, a patient may use the biometric data reader 110 to periodically monitor one of more of their biometric characteristics, such as blood pressure, insulin level, or weight. The patient has typically been performing the measurements of their biometric characteristics on a periodic basis for some time. For example, a patient may have been instructed by their doctor to take blood pressure readings several times a day. These readings are then relayed to the central server 130, typically for storage in the patient data repository, so that the records of the readings may be reviewed by a doctor or other caregiver if desired.

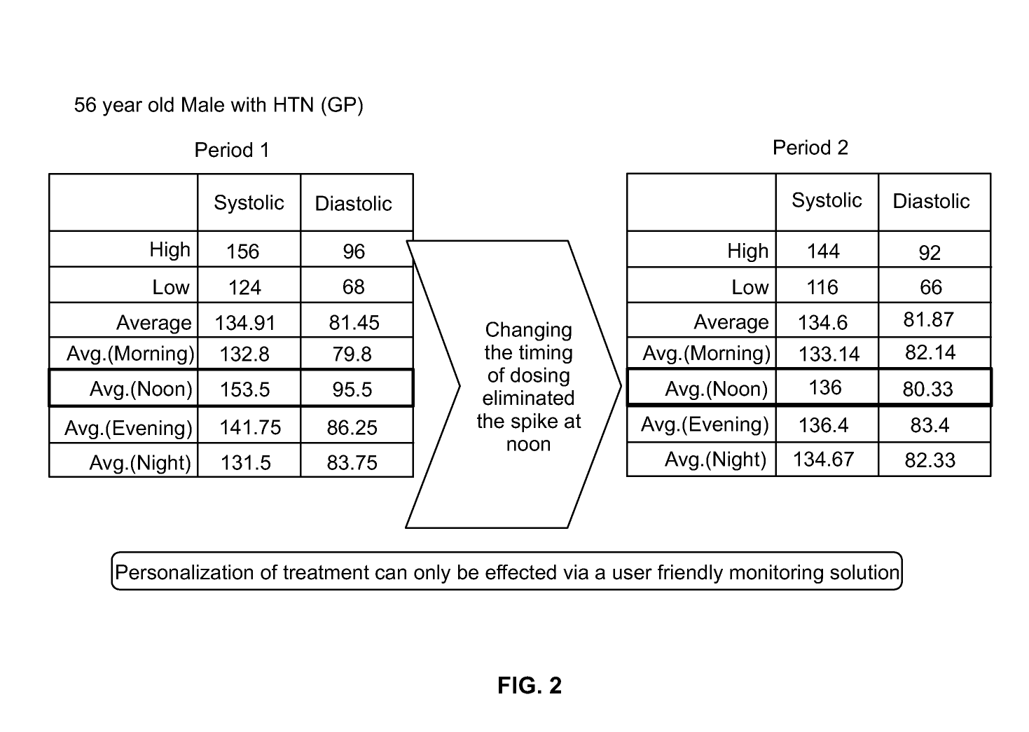

Because the patient is typically taking reading several times a day (for example, morning, noon, evening, and night) over several days, it is possible to determine 1) is the patient's medication working? and 2) are there spikes or troughs during the day so that it may be preferably to re-schedule the patient's time for taking the medication to remedy the spikes or troughs. One such example is shown in FIG. 2, below.

FIG. 2 illustrates a personalized modification of a medication schedule based on personally measured medical data. As shown in the Figure, a 56 year old male with hypertension was taking medication to control the hypertension. Although the medication was effective at remediating the hypertension during the morning evening and night readings, the noon readings exhibited a spike in blood pressure to unacceptable levels.

However, by changing the patient's timing of taking their medication, the spike at noon was eliminated. More specifically, instead of having the patient take their blood pressure medication when they got up in the morning, the patient was instructed to take their medication at 11 am. Consequently, more of the medication was available in the patient's system to combat the recurring spike in blood pressure at noon.

The effect of simply changing the timing of medication can be substantial. For example, as shown in FIG. 2, the average Systolic and Diastolic pressures declined by more than 15 points.

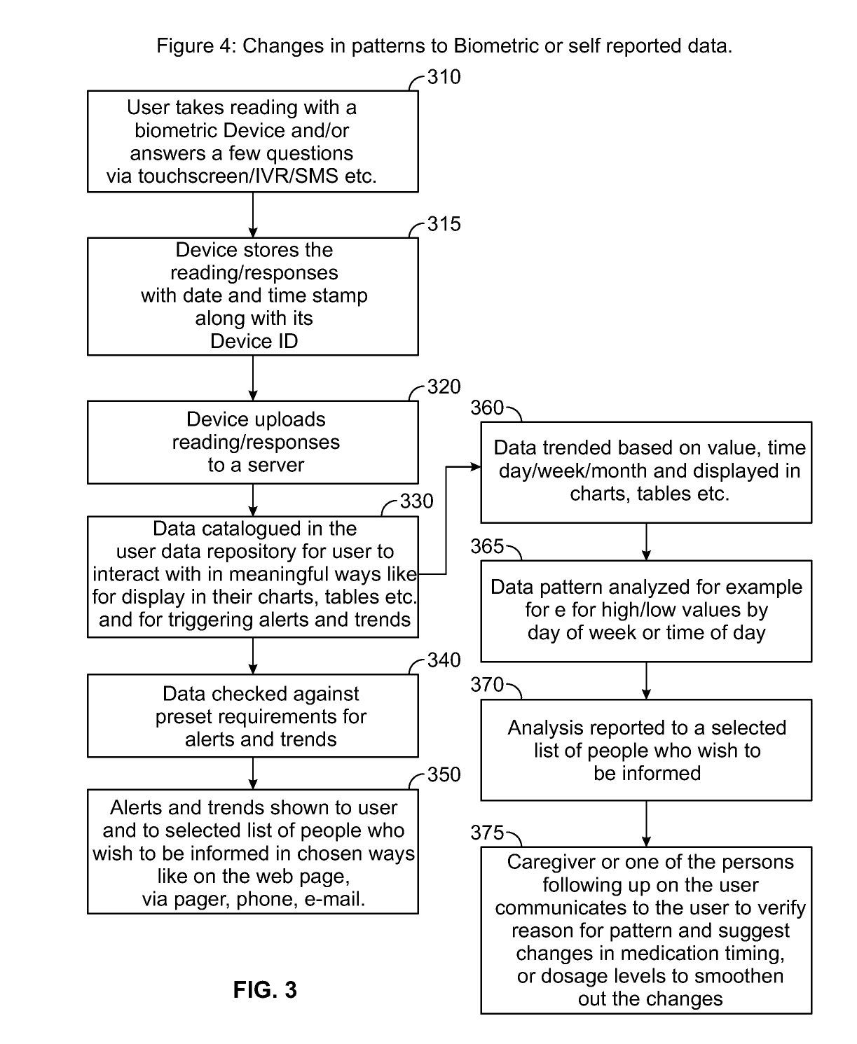

FIG. 3 illustrates a flowchart 300 of the personalized health care system. First, at step 310, a patient or user takes a reading with a biometric device. Alternatively or additionally, the user may answer one or more questions, and may do so using any of several systems, such as touch screen, Interactive Voice Response (IVR), or Short Message Service (SMS), for example.

Next, at step 315, the biometric and/or other device may store the reading and/or responses and may associate a date stamp, a time stamp, and a DeviceID with the readings. Next, at step 320, the device uploads the reading/and or responses to a server.

At step 330, once the readings/responses are received by the server, the reading data is catalogued in a user data repository along with their disease state, claims history and demographic information. The user may then interact with the data in meaningful ways, such as displaying the data in charts or tables. Additionally, the data may be used to trigger alerts and/or to determine trends or a normal condition.

Then, at step 340, the data that has been received from the patient is checked against preset requirements for alerts and/or trends. The alerts and/or trends at step 340 may be generalized population-wide measurements that may trigger an alert, such as any systolic blood pressure reading over 150, for example.

Next, at step 350, the alerts and/or trends may be shown to the patient and may also be shown to a selected list of other people such as doctors, nurses, or other caregivers, family members, or employers. Additionally, the alerts and/or trends may be transmitted to the desired persons using any of a variety of methodologies, such as making them available on an internet web page or through a pager, phone and/or e-mail.

Additionally, as recited at step 360, the data is trended based on value and time for the day, week, and/or month. Further the data and trends may be displayed in charts or tables.

Next, at step 365, the data is analyzed, for example for high and/or low values by day of week and time of day.

At step 370, the results of the analysis may be reported to a predetermined and selected group of people, such as the patient, family members, doctors, nurses, and/or other caregivers.

Finally, at step 375, a caregiver or other person receiving the information follows up with the patient to determine if there is a reason for an observed variance in results. Additionally, the caregiver may suggest one or more changes in medication timing or dosage levels or change medication itself in order to smooth out the measured impact on the patient.

Additionally, a variance on medication impact on the patient may be observed in comparing weekdays to week ends. For example, on weekends people may not be working and therefore their lifestyle is different for 2 days as compared to the five days during which they work. Today these changes in patient activity are not considered in developing a care program for the patient. Questions that are raised by changes in patient activity include, for example, should the patient take more medication on weekends or at a different time than weekdays. For some working people, they have different days off. What adjustments are needed for travel days and vacation days?

Fortunately, the system described above provides personalization of delivery of medication. A specific treatment can be personalized as to when one should take medication, how much and adjust it based on lifestyle etc. Real-time adjustments are possible to allow for changes in vital signs. For example, in one embodiment, the system keeps separate statistics on biometric data measured during the week as opposed to data measured during the weekend. Both sets of data may be analyzed and different medication times may be suggested based on the measured results.

In another embodiment, a spike in blood pressure, for example, is seen at night, the dosage may be doubled or user may be switched to a different medication. This same analysis may be performed for various biometric data values like blood sugar level, blood pressure, weight, Peak expiratory values, blood oxygen levels etc.

In another embodiment, a heart failure patient is fluctuating in weight by say 6 pounds in a day. They gain weight all day by accumulating fluid in the body and lose it overnight. Changing the timing of medication, in this case diuretics, to morning helped reduce the accumulation during the day and thus the fluctuation of weight.

In another embodiment, the glucose levels seems to increase on weekends since the patient's lifestyle is not as disciplined as compared to weekdays when they are working. In this case dosage levels were increased for weekends only

In another embodiment, asthma patients were exacerbating on Mondays. This was related to weekend outdoor activities during the fall season. Additional medication was added for the Sunday and Monday only during the fall season.

Consequently, this allows for intelligent titration of medication and personalization of medication the delivery by time of day.

Additionally, some conditions are seasonal in nature and impact more in certain months. Based on historical trending by month, medication may be increased or decreased, or switched, and another medication added when values increase or decrease to smoothen it out.

Additionally, although the biometric used in the above examples has been blood pressure, additional biometrics may be employed such as weight, insulin level

Other biometric values that may be used are Temperature, Blood oxygen, Insulin, Peak expiratory flow, Forced expiratory volume, Prothromin time (PT/INR), C-Reactive Protein, Creatine, Blood gas and electrolytes like Sodium, Potassium, Ionized Calcium, Hematocrit, Chloride, Urea Nitrogen, pH, PO₂, PCO₂, TCO₂, HCO₃, SO₂, Hemoglobin, Visual Acuity etc.

Biometric values and time may be collected using sensor devices in home or in lab. They may be further transferred to the Central server using a hub uing a phone line, internet, or cellular networks directly from the measuring sensor. Alternatively, the biometric values and time may be transcribed from the sensor by the patient or some one else and entered into a data entry system to then transfer to the central server. The data entry system may be a phone, tablet, PC, touch screen or keyboard device, transferring over the phone line, internet or cellular networks. Alternatively, the transcribed data may be reported via IVR. SMS, email, twitter etc. over the phone line, internet or cellular networks

Relevant disease state may be for example heart failure, diabetes, asthma, hypertension, COPD, obesity, Macular degeneration etc. Biometric data measured for heart failure patient would be blood pressure, weight and/or pulse oximeter readings.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. A system for providing personalized health care, said system including:
a biometric data reader reading a biometric characteristic of a patient and relaying said reading to a server;
a server comparing said biometric characteristic with a predetermined desirable value for said biometric characteristic; and
determining, when said biometric characteristic deviates from said desirable value, a change in the timing of the administration of pharmaceuticals to said patient.
